(19) United States
(12) Patent Application Publication
(10) Pub. No.: US 2026/0079428 A1
(43) Pub. Date: Mar. 19, 2026

(54) FIXING DEVICE

(71) Applicant: CANON KABUSHIKI KAISHA, Tokyo (JP)

(72) Inventors: TOMOYUKI KURIYAMA, Tokyo (JP); KENICHI TANAKA, Ibaraki (JP); RIKIYA TAKEMASA, Chiba (JP); TATSUO YASUI, Tokyo (JP); TAKUYA HASEGAWA, Tokyo (JP); TAKESHI KOZUMA, Ibaraki (JP); MASAKI FURUTANI, Chiba (JP)

(21) Appl. No.: 19/314,025

(22) Filed: Aug. 29, 2025

(30) Foreign Application Priority Data
Sep. 17, 2024 (JP) 2024-160020
Jun. 25, 2025 (JP) 2025-107223

(51) Int. Cl. G03G 15/20; G03G 15/00

(52) U.S. Cl. CPC G03G 15/2028; G03G 15/2032; G03G 15/2064; G03G 15/6573; G03G 2215/00417; G03G 2215/2025

(57) ABSTRACT

A separation member is configured to move from a first position to a second position by a first movement mechanism in conjunction with an operation in which a second rotary member moves from a contact position to a separated position by a second movement mechanism. The first position is a position where the recording material having passed through the nip portion is separable from the first rotary member by the separation member. The second position is a position where a distal end of the separation member is farther from the first rotary member than in the first position. The contact position is a position where the second rotary member comes into contact with the first rotary member. The separated position is a position where the second rotary member is separated from the first rotary member.

### BACKGROUND

### Field of the Technology

The present disclosure relates to a fixing device that heats a toner image borne on a recording material and fixes the toner image to the recording material.

### Description of the Related Art

An image forming apparatus such as a copying machine, a printer, a facsimile, or a multifunction peripheral combining such a plurality of functions includes a fixing device that fixes a toner image borne on a recording material to the recording material. As the fixing device, hitherto, a configuration in which the toner image on the recording material is conveyed while being heated at a nip portion formed by two rotary members has been known (JP 2014-202851 A).

JP 2014-202851 A describes a configuration including a separation member that is disposed downstream of the nip portion and separates the recording material that has passed through the nip portion from the rotary member. Since the separation member is required to be positioned with high accuracy with respect to the rotary member, JP 2014-202851 A discloses a configuration in which a part of the rotary member is in contact with an end portion of the separation member to ensure a gap between the separation member and the rotary member.

### SUMMARY

According to one aspect of the present disclosure, a fixing device is configured to heat a toner image borne on a recording material and fix the toner image to the recording material. The fixing device includes a first rotary member, a second rotary member configured to come into contact with the first rotary member and form a nip portion at which the recording material is nipped and conveyed between the second rotary member and the first rotary member, a separation member disposed downstream of the nip portion in a conveyance direction of the recording material and configured to separate the recording material having passed through the nip portion from the first rotary member, a separation member supporting portion configured to support the separation member so as to be movable between a first position and a second position, a first movement mechanism configured to move the separation member between the first position and the second position, and, a second movement mechanism configured to move the second rotary member between a contact position where the second rotary member comes into contact with the first rotary member and a separated position where the second rotary member is separated from the first rotary member. The first position is a position where, in a case where the second rotary member is at the contact position, a distal end of the separation member faces the first rotary member via a predetermined gap, and the recording material having passed through the nip portion is separable from the first rotary member by the separation member. The second position is a position where, in a case where the second rotary member is at the separated position, the distal end of the separation member is farther from the first rotary member than in the first position. The separation member is configured to move from the first position to the second position by the first movement mechanism in conjunction with an operation in which the second rotary member moves from the contact position to the separated position by the second movement mechanism.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating a configuration of an image forming apparatus according to an embodiment.

FIG. 2 is a control block diagram of the image forming apparatus according to the embodiment.

FIG. 3 is a schematic cross-sectional view illustrating a configuration of a fixing device according to the embodiment.

FIG. 4 is a perspective view of a discharge unit according to the embodiment when viewed from above.

FIG. 5 is a perspective view of the discharge unit according to the embodiment when viewed from a side.

FIG. 6 is a schematic cross-sectional view illustrating a configuration of a part of the fixing device to describe a positioning configuration for a separation member according to the embodiment.

FIG. 7 is a schematic cross-sectional view illustrating a configuration of the fixing device in a state in which the separation member according to the embodiment is positioned at a separation position.

FIG. 8 is a schematic cross-sectional view illustrating a configuration of the fixing device in a state in which the separation member according to the embodiment is positioned at a retraction position.

FIG. 9 is a schematic cross-sectional view illustrating a configuration of the fixing device in a state in which the discharge unit is positioned at an open position according to a comparative example.

FIG. 10 is a schematic cross-sectional view illustrating a configuration of the fixing device in a state in which the discharge unit is positioned at the open position according to the embodiment.

### DESCRIPTION OF THE EMBODIMENTS

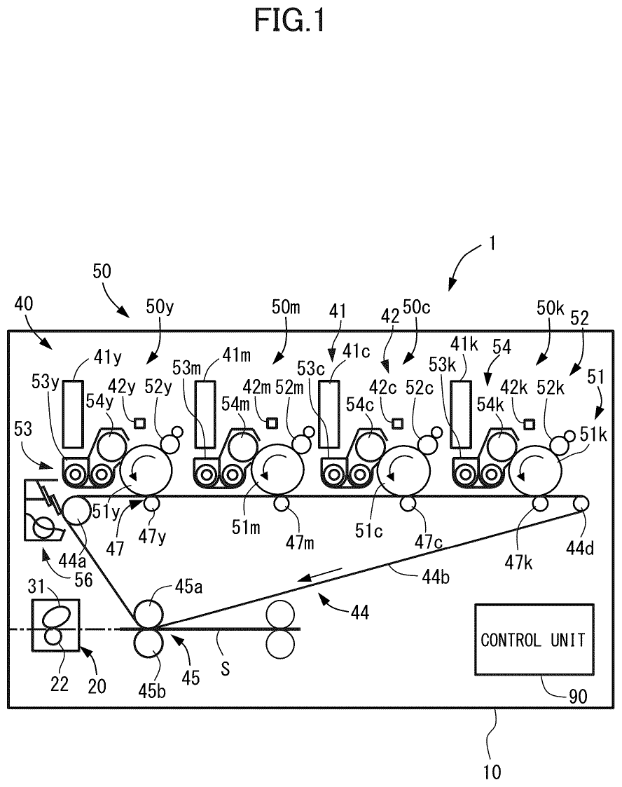

An embodiment will be described with reference to FIGS. 1 to 10. First, a schematic configuration of an image forming apparatus of the present embodiment will be described with reference to FIG. 1.

### Image Forming Apparatus

In the present embodiment, a tandem-type full-color printer will be described as an example of an image forming apparatus 1. However, the image forming apparatus is not limited to the tandem type, and may be applied to an image forming apparatus of another type. Further, the image forming apparatus is not limited to the full-color image forming apparatus, and may be a monochrome or mono-color image forming apparatus. Furthermore, the present technology can be implemented in various applications such as an image forming apparatus, a printer, various printing machines, a copying machine, a facsimile, and a multifunction peripheral.

As illustrated in FIG. 1, the image forming apparatus 1 includes an apparatus body 10, a sheet feeding portion (not illustrated), an image forming portion 40, and a control unit 90. The image forming apparatus 1 can form a four-color full-color image on a recording material according to an image signal from host equipment such as a document reading apparatus (not illustrated) or a personal computer, or external equipment such as a digital camera or a smartphone. A toner image is formed on a sheet S serving as the recording material, and specific examples of the sheet S include plain paper, a synthetic resin sheet as a substitute for plain paper, thick paper, and a sheet for an overhead projector.

### Image Forming Portion

The image forming portion 40 can form an image as an unfixed toner image on the sheet S fed from the sheet feeding portion based on image information. The image forming portion 40 includes image forming units 50y, 50m, 50c, and 50k, toner bottles 41y, 41m, 41c, and 41k, exposure devices 42y, 42m, 42c, and 42k, an intermediate transfer unit 44, a secondary transfer portion 45, and a fixing device 20. The image forming apparatus 1 of the present embodiment corresponds to full-color image formation, and the image forming units 50y, 50m, 50c, and 50k having the same configuration are individually provided for four colors of yellow (y), magenta (m), cyan (c), and black (k), respectively. For this reason, in FIG. 1, a component of each of four colors is denoted by the same reference numeral followed by a color identifier, but in the specification, description may be made only by the reference numeral without the color identifier.

The image forming unit 50 includes a photosensitive drum (photoconductor) 51 which is an example of an image bearing member that bears the toner image and rotates, a charging roller (charging member) 52, a developing device 53, and a cleaning blade (not illustrated). The image forming unit 50 is integrally unitized as a process cartridge, is configured to be attachable to and detachable from the apparatus body 10, and forms the toner image on an intermediate transfer belt 44b described below.

The photosensitive drum 51 is rotatable and bears an electrostatic latent image used for image formation. In the present embodiment, the photosensitive drum 51 is a negatively charged organic photoconductor (OPC) having an outer diameter of 30 mm, and is rotationally driven by a motor (not illustrated) in an arrow direction at a predetermined process speed (peripheral speed). As charging rollers 52y, 52m, 52c, and 52k, rubber rollers that are in contact with surfaces of the respective photosensitive drums 51 and rotate following the rotation of the respective photosensitive drums 51 are used, and the charging rollers 52y, 52m, 52c, and 52k uniformly charge the surfaces of the photosensitive drums 51. The exposure device 42 is a laser scanner, and emits laser light according to the image information of separated colors output from the control unit 90.

Developing devices 53y, 53m, 53c, and 53k include developing sleeves 54y, 54m, 54c, and 54k, respectively, and develop the electrostatic latent image formed on the photosensitive drums 51 with a toner by applying a developing bias. The developing device 53 stores a developer supplied from the toner bottle 41 and develops the electrostatic latent image formed on the photosensitive drum 51. The developing sleeve 54 is made of, for example, a nonmagnetic material such as aluminum or nonmagnetic stainless steel, and is made of aluminum in the present embodiment. A roller-shaped magnet roller is fixedly installed on an inner side of the developing sleeve 54 in a non-rotating state with respect to a developing container. The developing sleeve 54 bears the developer including a nonmagnetic toner and a magnetic carrier, and conveys the developer to a developing region facing the photosensitive drum 51.

The toner image developed on the surface of the photosensitive drum 51 is primarily transferred to the intermediate transfer unit 44. That is, the photosensitive drum 51 can bear the toner image by supplying the toner to the intermediate transfer belt 44b. After the primary transfer, the toner remaining on the photosensitive drum 51 without being transferred to the intermediate transfer unit 44 is removed by the cleaning blade provided in contact with the photosensitive drum 51, and preparation for the next image forming process is made.

The intermediate transfer unit 44 includes tensioning rollers such as a driving roller 44a, a driven roller 44d, and an inner secondary transfer roller 45a, a plurality of rollers such as primary transfer rollers 47y, 47m, 47c, and 47k, and the intermediate transfer belt 44b wound around the rollers and moving while bearing the toner image. The driven roller 44d is a tension roller that controls a tension of the intermediate transfer belt 44b to be constant. A force that pushes the intermediate transfer belt 44b toward a front surface side is applied to the driven roller 44d by a biasing force of a biasing spring (not illustrated). The primary transfer rollers 47y, 47m, 47c, and 47k are disposed to face the photosensitive drums 51y, 51m, 51c, and 51k, respectively, and are in contact with the intermediate transfer belt 44b to primarily transfer the toner images on the photosensitive drums 51 to the intermediate transfer belt 44b. That is, the intermediate transfer belt 44b moves (rotates) while bearing the toner image.

The intermediate transfer belt 44b is in contact with the photosensitive drum 51 to form a primary transfer portion with the photosensitive drum 51, and a primary transfer bias is applied to the intermediate transfer belt 44b, so that the toner image formed on the photosensitive drum 51 is primarily transferred at the primary transfer portion. As the intermediate transfer belt 44b is applied the primary transfer bias having a positive polarity via the primary transfer rollers 47, the toner images having a negative polarity on the photosensitive drums 51 are sequentially transferred to the intermediate transfer belt 44b in a superimposed manner. The intermediate transfer belt 44b is provided with a belt cleaning device 56 that cleans a residual toner after transfer on the intermediate transfer belt 44b.

The secondary transfer portion 45 includes the inner secondary transfer roller 45a and an outer secondary transfer roller 45b. The outer secondary transfer roller 45b is in contact with the intermediate transfer belt 44b, and a secondary transfer bias having a polarity opposite to that of the toner is applied at a nip portion with the intermediate transfer belt 44b. As a result, the outer secondary transfer roller 45b secondarily transfers the toner images borne on the intermediate transfer belt 44b collectively to the sheet S supplied to the nip portion.

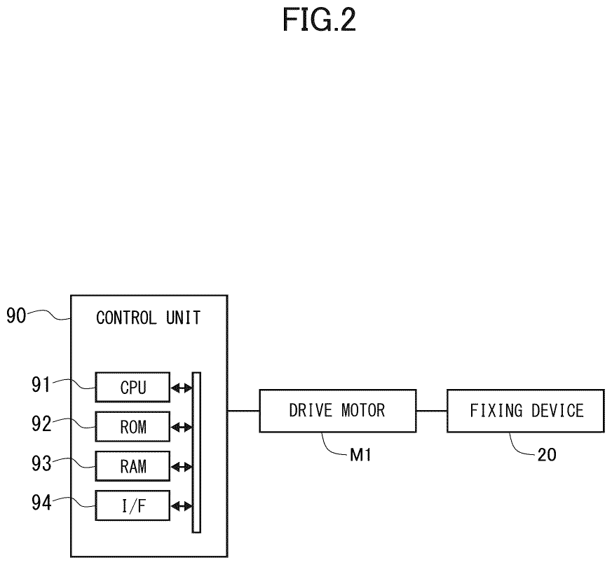

The fixing device 20 includes a fixing belt 31 and a pressure roller 22. When the sheet S is nipped between the fixing belt 31 and the pressure roller 22 and conveyed in a sheet conveyance direction, the toner image formed by the image forming portion 40 and transferred to the sheet S is fixed to the sheet S by being heated and pressurized. The fixing device 20 is driven by a drive motor M1 (see FIG. 2) housed in the fixing device 20. Details of the fixing device 20 will be described below.

### Control Unit

As illustrated in FIG. 2, the control unit 90 is implemented by a computer, and includes, for example, a central processing unit (CPU) 91, a read only memory (ROM) 92 that stores a program for controlling each unit, a random access memory (RAM) 93 that temporarily stores data, and an input/output circuit (I/F) 94 that receives and outputs a signal from and to the outside. The CPU 91 is a microprocessor that performs overall control of the image forming apparatus 1, and is a main part of a system controller. The CPU 91 is connected to an operation unit, the sheet feeding portion, the image forming portion 40, and the like via the input/output circuit 94, exchanges a signal with each unit, and controls an operation. The drive motor M1 of the fixing device 20 is connected to the control unit 90, and the control unit 90 can control an operation of the fixing device 20. The ROM 92 stores an image formation control sequence and the like for forming an image on the sheet S.

### Image Forming Operation

Next, an image forming operation in the image forming apparatus 1 configured as described above will be described. When the image forming operation is started, the photosensitive drum 51 first rotates, and the surface of the photosensitive drum 51 is charged by the charging roller 52. Then, the exposure device 42 emits the laser light to the photosensitive drum 51 based on the image information, and the electrostatic latent image is formed on the surface of the photosensitive drum 51. As the toner adheres to the electrostatic latent image, the electrostatic latent image is developed, visualized as the toner image, and transferred to the intermediate transfer belt 44b.

Meanwhile, in parallel with such a toner image forming operation, the sheet S is supplied and conveyed to the secondary transfer portion 45 via a conveyance path in synchronization with the toner image on the intermediate transfer belt 44b. Further, the sheet S to which the image has been transferred from the intermediate transfer belt 44b is conveyed to the fixing device 20. Then, the unfixed toner image is heated and pressurized in the fixing device 20 and fixed to a surface of the sheet S. The sheet S on which the toner image is fixed is discharged from the apparatus body 10.

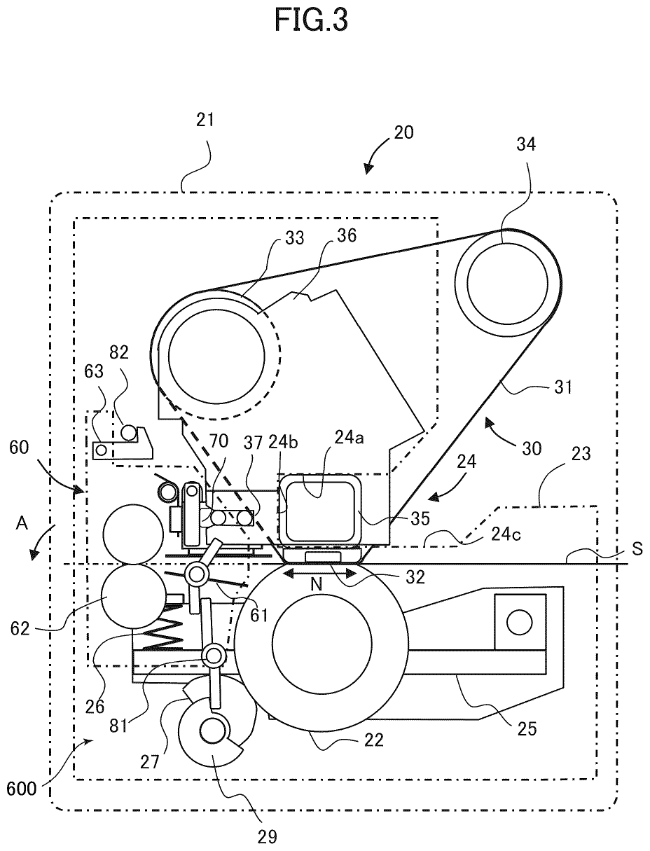

Next, the fixing device 20 will be described in detail with reference to FIGS. 3 to 10. As illustrated in FIG. 3, the fixing device 20 is a belt heating type heating device, and is formed to have a cartridge-like structure attachable to and detachable from the apparatus body 10 (see FIG. 1). The fixing device 20 includes a casing 21, a heating unit 30, the pressure roller 22, and a discharge unit 60. The heating unit 30 includes the fixing belt 31 serving as a rotatable first rotary member, a pressure pad 32 serving as a nip portion forming member, a heating roller 33, a steering roller 34, a stay 35 serving as a supporting member, and a unit side plate 36 integrating these components in a cartridge-like structure.

The fixing belt 31 serving as an endless belt is a thin cylindrical belt member that can heat the sheet S by being in contact with the sheet S and has thermal conductivity, heat resistance, and the like. In the present embodiment, the fixing belt 31 has a three-layer structure in which a base layer, an elastic layer on an outer periphery of the base layer, and a releasable layer on an outer periphery of the elastic layer are formed. The base layer has a thickness of 30 μm and is made of polyimide resin (PI), the elastic layer has a thickness of 300 μm and is made of silicone rubber, and the releasable layer has a thickness of 30 μm and is made of perfluoroalkoxy alkane (PFA) serving as a fluororesin. The fixing belt 31 is stretched by the pressure pad 32, the heating roller 33, and the steering roller 34.

The pressure pad 32 is disposed on an inner side of the fixing belt 31 at a position facing the pressure roller 22 via the fixing belt 31, and forms a fixing nip portion N at which the sheet S is nipped and conveyed between the fixing belt 31 and the pressure roller 22. The pressure pad 32 is pressed by the pressure roller 22 with the fixing belt 31 interposed therebetween. The fixing nip portion N is formed by a contact portion between the fixing belt 31 and the pressure roller 22. A lubricating sheet or a lubricant is interposed between the pressure pad 32 and the fixing belt 31, and the fixing belt 31 smoothly slides with respect to the pressure pad 32.

The heating roller 33 is a stainless steel pipe having a thickness of 1 mm, has a halogen heater (not illustrated) disposed therein, and can generate heat up to a predetermined temperature. The fixing belt 31 is heated by the heating roller 33, and is controlled to a predetermined target temperature corresponding to a sheet type based on temperature detection by a thermistor. Further, the heating roller 33 has a gear (not illustrated) fixed to one end portion in a rotation axis direction (hereinafter, also referred to as a width direction W), and is connected to the drive motor M1 (see FIG. 2) via the gear and rotationally driven. The fixing belt 31 is driven to rotate following the rotation of the heating roller 33. The width direction W is the rotation axis direction of the pressure roller 22 that is orthogonal to the conveyance direction of the sheet S passing through the fixing nip portion N.

The steering roller 34 has a swing center in a substantially vertical direction at one end portion in the rotation axis direction or in the vicinity of a central portion, and pivots with respect to the fixing belt 31 to generate a tension difference in a main scanning direction (width direction W) and adjust a position of the fixing belt 31 in the width direction W. The steering roller 34 is biased by a biasing spring (not illustrated) supported by a frame of the heating unit 30, and is also a tension roller that applies a predetermined tension to the fixing belt 31.

The pressure pad 32 is made of liquid crystal polymer (LCP), and is supported by the stay 35 serving as a supporting member. A surface of the pressure pad 32 that faces the pressure roller 22 is a smooth curved surface having a convex shape toward the pressure roller 22, and has a crown shape with a curvature radius of 700μm in the width direction W. The stay 35 is made of stainless steel, and both ends of the stay 35 in the width direction W are supported by a fixing frame 23 of the casing 21 of the fixing device 20.

The pressure roller 22 serving as a second rotary member faces and comes into contact with the fixing belt 31, and forms the fixing nip portion N pressurized between the pressure roller 22 and the fixing belt 31. The pressure roller 22 is a roller in which an elastic layer is formed on an outer periphery of a shaft and a releasable layer is formed on an outer periphery of the elastic layer. The shaft is made of stainless steel, the elastic layer has a thickness of 3 mm and is made of conductive silicone rubber, and the releasable layer has a thickness of 30 μm and is made of PFA serving as a fluororesin. The pressure roller 22 is supported by a pressure frame 25, has a gear fixed to one end portion in the rotation axis direction, is connected to the drive motor M1 (see FIG. 2) via the gear, and is rotationally driven.

In the fixing nip portion N formed between the fixing belt 31 and the pressure roller 22, the sheet bearing the toner image is nipped and conveyed and the toner image is heated. In this manner, the fixing device 20 fixes the toner image to the sheet while nipping and conveying the sheet. Therefore, it is necessary to achieve both a function of applying heat or pressure and a function of conveying the sheet.

The fixing frame 23 is fixed to both side portions of the casing 21 in the width direction W, and is provided with a guide portion 24, the pressure frame 25, a pressure spring 26, and a pressure cam 27. The stay 35 of the heating unit 30 is inserted into the guide portion 24 and fixed to the guide portion 24 by a fixing member (not illustrated). After the stay 35 is fixed to the guide portion 24, the pressure frame 25 moves toward the heating unit 30 by a drive source (not illustrated) and the pressure cam 27, whereby the pressure roller 22 is pressurized against the pressure pad 32 via the fixing belt 31.

The guide portion 24 has a supporting surface (supporting portion) 24a, a positioning surface (positioning portion) 24b, and a sliding surface 24c. In FIG. 3, the heating unit 30 is positioned at a mounting position. The supporting surface 24a is formed in the sheet conveyance direction on a side facing the pressure roller 22, and supports a reaction force received by the fixing belt 31 from the pressure roller 22 on an inner peripheral side of the fixing belt 31 when the heating unit 30 is positioned at the mounting position. The positioning surface 24b is formed substantially vertically at the rearmost portion of the guide portion 24 in a direction in which the heating unit 30 is inserted, and when the heating unit 30 is positioned at the mounting position, the positioning surface 24b comes into contact with the heating unit 30 in an insertion direction to position the heating unit 30. The sliding surface 24c is formed in the sheet conveyance direction so as to face the supporting surface 24a, and slides and guides the stay 35 when the heating unit 30 is inserted and removed.

### Discharge Unit

Next, the discharge unit 60 serving as a unit including a separation plate 71 described below will be described. The discharge unit 60 for discharging the sheet S having passed through the fixing nip portion N to the outside of the fixing device 20 is disposed downstream of the fixing nip portion N in the conveyance direction of the sheet S. In the discharge unit 60, a separation unit 70 that guides the sheet S separated from the fixing belt 31 after passing through the fixing nip portion N, a discharge lower guide 61, and a conveyance roller pair 62 serving as a conveyance portion for discharging the separated sheet S to the outside of the fixing device 20 are disposed. The conveyance roller pair 62 is disposed about 40 mm downstream of the fixing nip portion N in the conveyance direction.

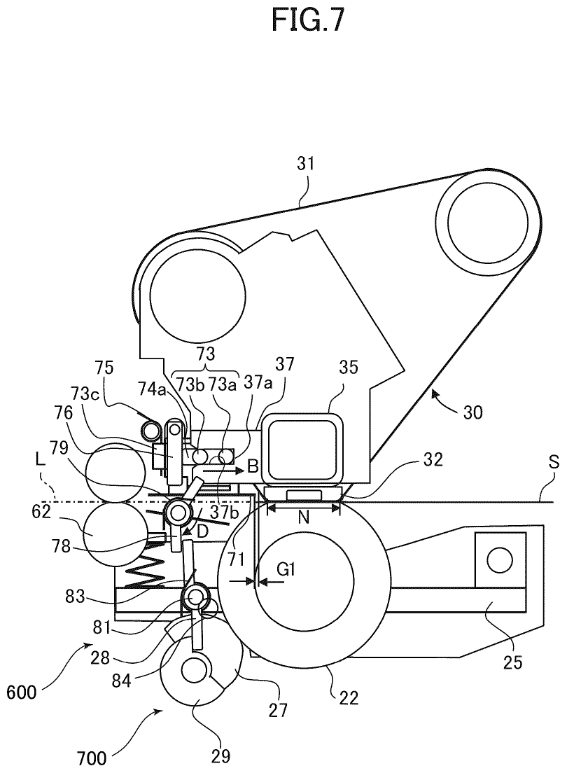

The discharge unit 60 is pivotable about a pivot shaft 84 (see FIGS. 7 to 10) provided on the fixing frame 23, and when the sheet S is jammed at an outlet of the fixing nip portion N, the discharge unit 60 can pivot in a direction of an arrow A to expose the fixing nip portion N, so that the jammed sheet S can be removed. That is, as described in detail below, the discharge unit 60 can be moved by an opening/closing mechanism 600 serving as a third movement mechanism to a closed position (third position) where the separation plate 71 faces the fixing belt 31 and an open position (fourth position) where the separation plate 71 is farther from the fixing nip portion N than in the closed position and the sheet S jammed at the fixing nip portion N can be removed. The closed position is a position where the discharge unit 60 does not open a downstream side of the fixing nip portion N in the conveyance direction of the sheet S, and the open position is a position where the discharge unit 60 opens the downstream side of the fixing nip portion N in the conveyance direction of the sheet S. Hereinafter, unless otherwise specified, the term “downstream” means a downstream side in the conveyance direction of the sheet S.

The opening/closing mechanism 600 includes the pivot shaft 84 that pivotably supports the discharge unit 60, a locking shaft 82 provided on the fixing frame 23, and a locking member 63 provided on the discharge unit 60. The discharge unit 60 is positioned with respect to the fixing frame 23 by engaging the locking member 63 with the locking shaft 82. In this state, the discharge unit 60 is positioned at the closed position. On the other hand, as the locking member 63 and the locking shaft 82 are disengaged in this state, and the discharge unit 60 pivots about the pivot shaft 84 in a direction away from the fixing nip portion N (the direction of the arrow A), the discharge unit 60 is positioned at the open position. Then, in this state, jam processing is performed.

### Separation Unit

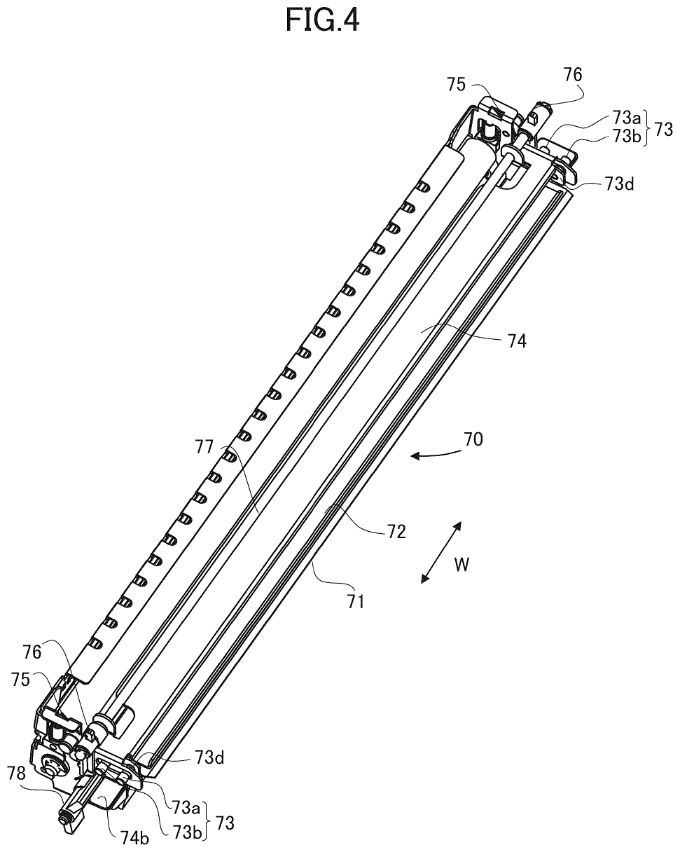

Next, the separation unit 70 will be described in detail with reference to FIGS. 4, 5, and 6. The separation unit 70 is provided in the discharge unit 60 (see FIG. 3). The separation unit 70 of the present embodiment includes the separation plate 71 serving as the separation member, a separation plate supporting member 72 that supports the separation plate 71, a separation plate regulating portion 73 that regulates a movement direction of the separation plate 71, a separation guide 74 serving as a separation member supporting portion that supports the separation plate supporting member 72, and a torsion coil spring 75 serving as a biasing portion. The separation plate 71 is made of a metal plate, and is formed by attaching a fluorine-based tape in order to prevent toner adhesion from the sheet due to sliding, image damage, and the like.

The separation plate supporting member 72 is provided with the separation plate regulating portion 73, and has a role of regulating the movement direction of the separation plate 71 with respect to the separation guide 74. The separation plate regulating portion 73 includes a first guide shaft 73a and a second guide shaft 73b serving as separation-member-side engagement portions on both side portions in the width direction W. Spring hooked portions 73c with which end portions of the torsion coil spring 75 are engaged are provided on both sides of the separation plate supporting member 72 in the width direction W.

Meanwhile, the separation guide 74 includes a guide groove 74a in which the first guide shaft 73a and the second guide shaft 73b are roughly engaged with a predetermined gap, and a fastening portion 74b which is a fastening surface with respect to the discharge unit 60. By engaging the first guide shaft 73a and the second guide shaft 73b provided on the separation plate supporting member 72 that supports the separation plate 71 with the guide groove 74a provided in the separation guide 74, the separation plate 71 is movable to a separation position (first position) and a retraction position (second position) described below with respect to the separation guide 74. That is, the guide groove 74a serving as a supporting-portion-side guide portion guides the first guide shaft 73a and the second guide shaft 73b to the separation position and the retraction position. Side surface portions 73d are provided substantially vertically at both end portions of the separation plate supporting member 72 in the width direction W. The first guide shaft 73a and the second guide shaft 73b are provided so as to extend outward from the side surface portion 73d such that the axial center coincides with the width direction W, and are arranged side by side in the sheet conveyance direction.

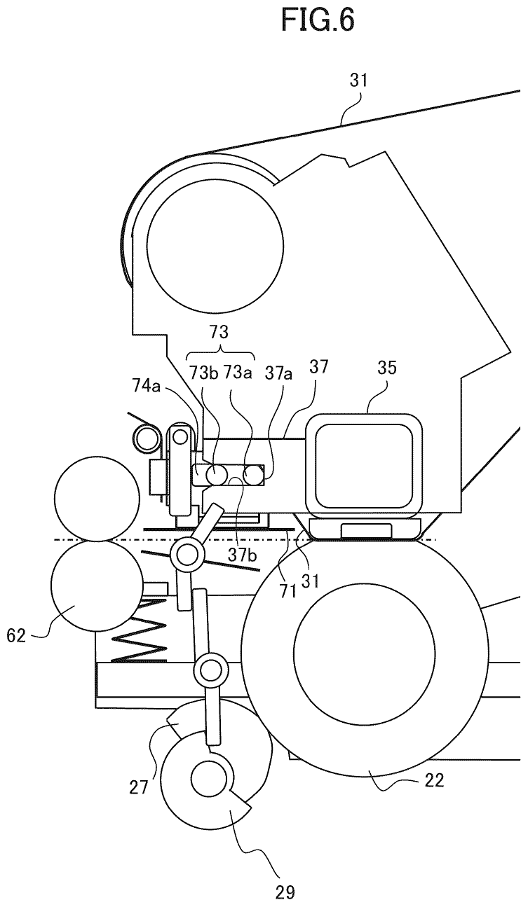

A direction in which the separation plate 71 is moved by the first guide shaft 73a and the second guide shaft 73b is determined by the guide groove 74a of the separation guide 74. When the separation unit 70 is biased by the torsion coil spring 75 in a direction of an arrow B that is substantially the same as the determined movement direction, the first guide shaft 73a of the separation unit 70 comes into contact with a contact surface 37a (FIG. 6) of the separation positioning portion 37 serving as a positioning member provided on the stay 35 of the heating unit 30. Accordingly, the separation plate 71 can be positioned at the separation position.

Retraction arms 76 are provided at both end portions of the separation guide 74 in the width direction W, and are pivotally supported by a retraction arm shaft 77 pivotably supported by the separation guide 74. A retraction lever 78 is pivotably provided at one end of the discharge unit 60 in the width direction W, and is biased so as to come into contact with an end portion of the retraction arm 76 by a torsion coil spring 79 serving as a biasing portion. When the retraction lever 78 is biased by the torsion coil spring 79, the retraction arm 76 coming into contact with the retraction lever 78 is biased in a direction of an arrow C, and the retraction arm 76 biases the spring hooked portion 73c provided on the separation plate supporting member 72 in the direction of the arrow C.

In the present embodiment, as described in detail below, the above-described mechanism including the torsion coil spring 75, the retraction arm 76, the retraction lever 78, the torsion coil spring 79, and a separation movement cam 29 corresponds to a separation plate movement mechanism 700 serving as a first movement mechanism capable of moving the separation plate 71 between the separation position and the retraction position. In the above description, the biasing portion is a torsion coil spring, but the present technology is not limited thereto, and for example, the same effect can be obtained with other biasing members such as a tension spring and a compression spring. Further, the biasing portion for biasing the separation plate 71, such as the torsion coil spring 79, may be provided at a position outside the separation unit 70, for example, a position on the fixing frame 23.

### Separation Positioning Portion of Heating Unit

Next, a positioning configuration of the separation plate 71 provided in the heating unit 30 will be described in detail with reference to FIG. 6. The stay 35 is provided with the separation positioning portion 37 as the positioning member that positions the separation plate 71 at the separation position. The separation positioning portion 37 is engageable with the first guide shaft 73a and the second guide shaft 73b provided on the separation plate supporting member 72, and includes a guide groove 37b serving as a guide portion that guides the separation plate 71 supported by the separation plate supporting member 72 to the separation position and the retraction position described below. When the first guide shaft 73a and the second guide shaft 73b are engaged with the guide groove 37b of the separation positioning portion 37, a position of the separation unit 70 with respect to the fixing belt 31 is determined.

Specifically, as illustrated in FIG. 6, the separation plate 71 is positioned in a direction toward the fixing belt 31 at a position where the first guide shafts 73a at both end portions of the separation plate supporting member 72 are engaged with the contact surfaces 37a of the guide grooves 37b. The second guide shaft 73b and the guide groove 37b are engaged with each other to stop rotation of the separation plate 71. As a result, the separation unit 70 including the separation plate 71 and the stay 35 can be positioned. An aspect of the engagement between the guide groove 37b of the separation positioning portion 37 and the first guide shaft 73a and the second guide shaft 73b is not limited to the above-described configuration, and other configurations can be appropriately applied.

### Movement Configuration of Separation Plate

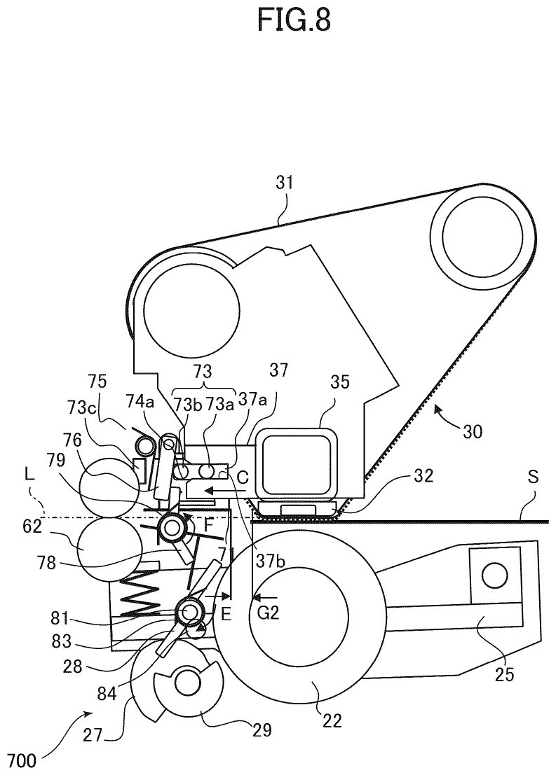

Next, a movement configuration of the separation plate 71 will be described in detail with reference to FIGS. 7 and 8. FIG. 7 illustrates a state in which the separation plate 71 is at the separation position, and FIG. 8 illustrates a state in which the separation plate 71 is at the retraction position. As described above, the separation plate 71 is movable to the separation position serving as the first position and the retraction position serving as the second position by the separation plate movement mechanism 700 serving as the first movement mechanism. The separation position is a position where a distal end of the separation plate 71 faces the fixing belt 31 via a predetermined gap in a state in which the discharge unit 60 is positioned at the closed position, and the sheet having passed through the fixing nip portion N can be separated from the fixing belt 31 by the separation plate 71. The retraction position is a position where the distal end of the separation plate 71 is farther from the fixing belt 31 than in the separation position in a state in which the discharge unit 60 is positioned at the closed position. The separation plate movement mechanism 700 includes the torsion coil spring 75 serving as the biasing portion, the retraction arm 76, the retraction lever 78, the torsion coil spring 79, a separation movement lever 28, a torsion coil spring 83, and the separation movement cam 29.

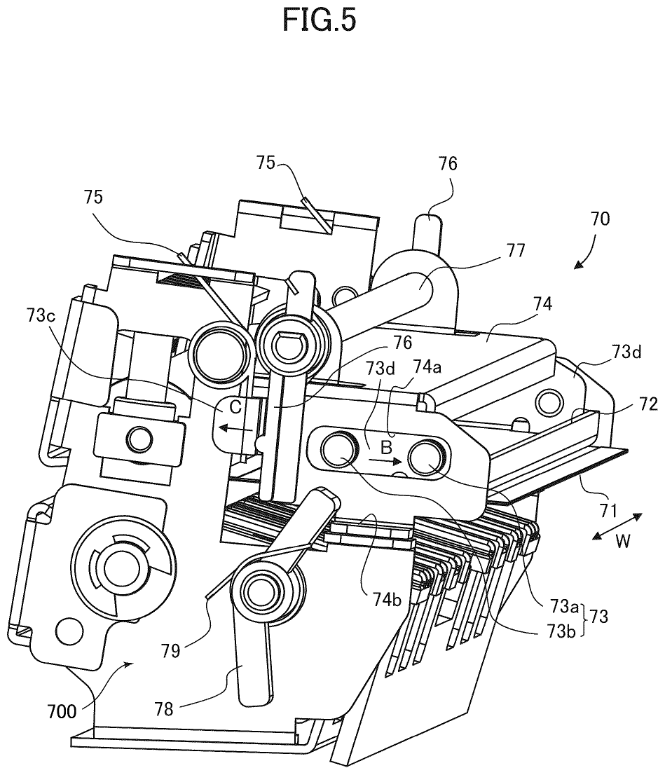

The separation plate supporting member 72 that supports the separation plate 71 is provided with the spring hooked portion 73c on which the torsion coil spring 75 is hooked. The torsion coil spring 75 biases the separation plate 71 in a direction from the retraction position to the separation position via the spring hooked portion 73c. The retraction arm 76 is pivotably supported with respect to the separation guide 74 (FIG. 5) serving as the separation member supporting portion. In addition, the retraction arm 76 can come into contact with the spring hooked portion 73c, and when the retraction arm 76 is pushed by the retraction lever 78 as described below, the retraction arm 76 pushes the spring hooked portion 73c, and the separation plate supporting member 72 moves against a biasing force of the torsion coil spring 75. As a result, the separation plate 71 moves from the separation position to the retraction position together with the separation plate supporting member 72.

The retraction lever 78 is pivotably supported by a side plate of the discharge unit 60, and is biased by the torsion coil spring 79 so as to come into contact with the end portion of the retraction arm 76. In a state illustrated in FIG. 7, the retraction lever 78 is pushed by the separation movement lever 28 and pivots in a direction against a biasing force of the torsion coil spring 79, and the retraction lever 78 does not come into contact with the retraction arm 76. Therefore, the separation plate 71 is positioned at the separation position by the biasing force of the torsion coil spring 75.

The separation movement lever 28 is pivotably supported with respect to a link pivot center 81 provided on the side plate of the discharge unit 60, and can come into contact with the retraction lever 78. The torsion coil spring 83 biases the separation movement lever 28 in a direction away from the retraction lever 78. The separation movement cam 29 is supported by a frame (for example, the fixing frame 23 (FIG. 3)) of the fixing device 20 and rotates together with the pressure cam 27 described below. In addition, the separation movement cam 29 can be engaged with the separation movement lever 28, and pivots the separation movement lever 28 against a biasing force of the torsion coil spring 83 in a state of being engaged with the separation movement lever 28 as illustrated in FIG. 7. In this state, the separation movement lever 28 pivots the retraction lever 78 in a direction of an arrow D such that the retraction lever 78 does not come into contact with the retraction arm 76.

Here, in the present embodiment, the pressure cam 27 serving as a second movement mechanism capable of moving the pressure roller 22 is provided. The pressure cam 27 can move the pressure roller 22 to a contact position (FIG. 7) where the pressure roller 22 comes into contact with the fixing belt 31 and a separated position (FIG. 8) where the pressure roller 22 is separated from the fixing belt 31. Then, the separation plate movement mechanism 700 moves the separation plate 71 from the separation position to the retraction position in conjunction with an operation in which the pressure roller 22 moves from the contact position to the separated position by the pressure cam 27. That is, the separation movement cam 29 of the separation plate movement mechanism 700 has the same pivot center as the pressure cam 27 and is configured to rotate together with the pressure cam 27. Therefore, when the pressure cam 27 rotates by the drive source (not illustrated), the separation movement cam 29 also rotates together with the pressure cam 27. Even at the separated position where the pressure roller 22 is separated from the fixing belt 31, the fixing belt 31 continues to rotate while the heating roller 33 heats the belt. Hereinafter, a specific description will be given.

As illustrated in FIG. 7, when the separation plate 71 is present at the separation position, the pressure frame 25 moves toward the heating unit 30 by the drive source (not illustrated) and the pressure cam 27, so that the pressure roller 22 is pressurized against the pressure pad 32 via the fixing belt 31 to form the fixing nip portion N. In the fixing nip portion N, the crown shape of the pressure pad 32 and a contact pressure of the pressure roller 22 are adjusted, so that the entire fixing nip portion N becomes substantially flat in the width direction at the time of fixing a medium.

At this time, the separation movement lever 28 provided at the link pivot center 81 rotates together with the pressure cam 27 by the separation movement cam 29, and accordingly, the retraction lever 78 pivots in the direction of the arrow D. When the retraction lever 78 pivots in the direction of the arrow D, the separation plate regulating portion 73 moves in the direction of the arrow B together with the separation plate 71 by the biasing force of the torsion coil spring 75. Then, the first guide shaft 73a of the separation plate regulating portion 73 is engaged with and comes into contact with the contact surface 37a of the separation positioning portion 37 provided on the stay 35. That is, the separation plate movement mechanism 700 allows the separation plate 71 to be biased by the torsion coil spring 75 and positioned at the separation position in a state in which the pressure roller 22 is positioned at the contact position. As a result, the separation plate 71 is positioned such that a gap (predetermined gap) between the fixing belt 31 and the distal end of the separation plate 71 becomes G1, and the entire fixing nip portion N becomes substantially flat in the width direction. Therefore, the entire gap G1 can be guaranteed to be substantially 500 μm in the width direction.

As described above, in a state in which the separation plate 71 is present at the separation position, the entire gap G1 between the fixing belt 31 and the separation plate 71 is guaranteed to be approximately 500 μm in the width direction, so that various media separated from the fixing belt 31 can be guided from the outlet of the fixing nip portion N to the conveyance roller pair (discharge roller pair) 62 without being jammed in the gap between the fixing belt 31 and the separation plate 71.

As illustrated in FIG. 8, when the separation plate 71 is present at the retraction position, the pressure frame 25 moves in a direction away from the heating unit 30 by the drive source (not illustrated) and the pressure cam 27, so that the pressure roller 22 is brought into a non-contact state with respect to the fixing belt 31. At this time, when the separation movement cam 29 provided coaxially with the pressure cam 27 is separated from the separation movement lever 28 provided at the link pivot center 81, the separation movement lever 28 pivots in a direction of an arrow E by the biasing force of the torsion coil spring 83.

When the separation movement lever 28 pivots in the direction of the arrow E, the retraction lever 78 pivots in the direction of the arrow F by the biasing force of the torsion coil spring 79. When the retraction lever 78 pivots in a direction of an arrow F, the retraction arm 76 pivots against the biasing force of the torsion coil spring 75, and moves the separation plate 71 in the direction of the arrow C via the spring hooked portion 73c. Then, the separation plate regulating portion 73 moves together with the separation plate 71 in the direction of the arrow C by the retraction arm 76, and the second guide shaft 73b of the separation plate regulating portion 73 comes into contact with the guide groove 74a of the separation guide 74.

In a state in which the second guide shaft 73b comes into contact with the guide groove 74a, the first guide shaft 73a is retracted from the contact surface 37a by a predetermined amount (20 mm in the present embodiment) in a state of being engaged with the guide groove 37b of the separation positioning portion 37 provided on the stay 35. That is, the separation plate movement mechanism 700 causes the separation plate 71 to be positioned at the retraction position against the biasing force of the torsion coil spring 75 in a state in which the pressure roller 22 is positioned at the separated position. As described above, the separation plate 71 moves from the separation position to the retraction position in conjunction with an operation of moving the pressure roller 22 to the separation position. In a state in which the separation plate 71 is present at the retraction position, a gap G2 larger than the gap G1 is formed between the distal end of the separation plate 71 and the fixing belt 31.

In order to remove the jammed recording material in the fixing nip portion N, it is conceivable to move the discharge unit 60 including the separation plate 71 disposed downstream of the fixing nip portion N in a direction away from the fixing belt 31 to form a space for removing (jam processing) the jammed recording material. However, the separation plate 71 protrudes toward the fixing belt 31 at a position downstream of the fixing nip portion N, and is disposed such that a predetermined gap is formed between the separation plate 71 and the fixing belt 31. Therefore, in the case of a configuration including the separation plate 71, even if the discharge unit 60 is moved in a direction away from the fixing belt 31 to perform the jam processing, there is a problem that it is difficult to secure the space for the jam processing since the separation plate 71 protrudes, and the jam processing is difficult to execute.

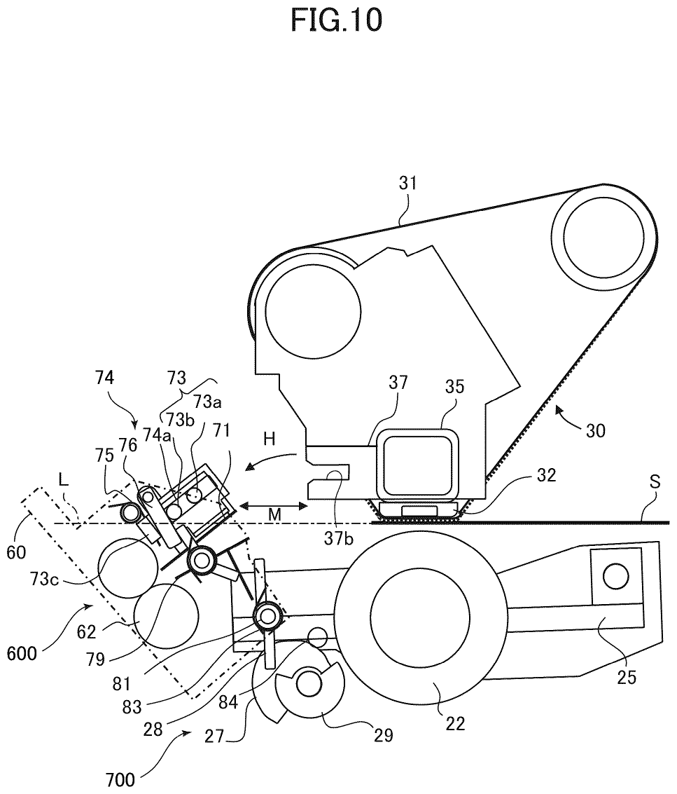

In the present embodiment, when a jam is detected in the fixing nip portion N, the pressure roller 22 moves to the retraction position, and the opening/closing mechanism 600 can pivot the discharge unit 60 from the closed position to the open position where the jam processing can be performed in order to remove the jammed sheet in the fixing nip portion N. As illustrated in FIGS. 7 and 8, in a state in which the discharge unit 60 is positioned at the closed position, at least the first guide shaft 73a among the first guide shaft 73a and the second guide shaft 73b is engaged with the guide groove 37b of the separation positioning portion 37. When the discharge unit 60 moves from the closed position to the open position, the first guide shaft 73a and the second guide shaft 73b are disengaged from the guide groove 37b as illustrated in FIG. 10 described below. At this time, the first guide shaft 73a and the second guide shaft 73b are engaged with the guide groove 74a of the separation guide 74, and the spring hooked portion 73c is biased by the torsion coil spring 75 via the retraction arm 76, whereby a state in which the separation plate 71 is positioned at the retraction position is maintained.

As described above, even when the discharge unit 60 pivots from the closed position to the open position in a state in which the separation plate 71 is positioned at the retraction position, the position of the separation plate 71 remains at the retraction position. That is, the separation plate movement mechanism 700 can position the separation plate 71 at the separation position or the retraction position regardless of an operation of the opening/closing mechanism 600, and normally moves the pressure roller 22 to the separated position and then moves the discharge unit 60 to the open position in the case of performing the jam processing. Therefore, the separation plate 71 is positioned at the retraction position in a state in which the discharge unit 60 is positioned at the open position.

### Effect of Expansion of Jam Processing Space by Separation Plate Retraction

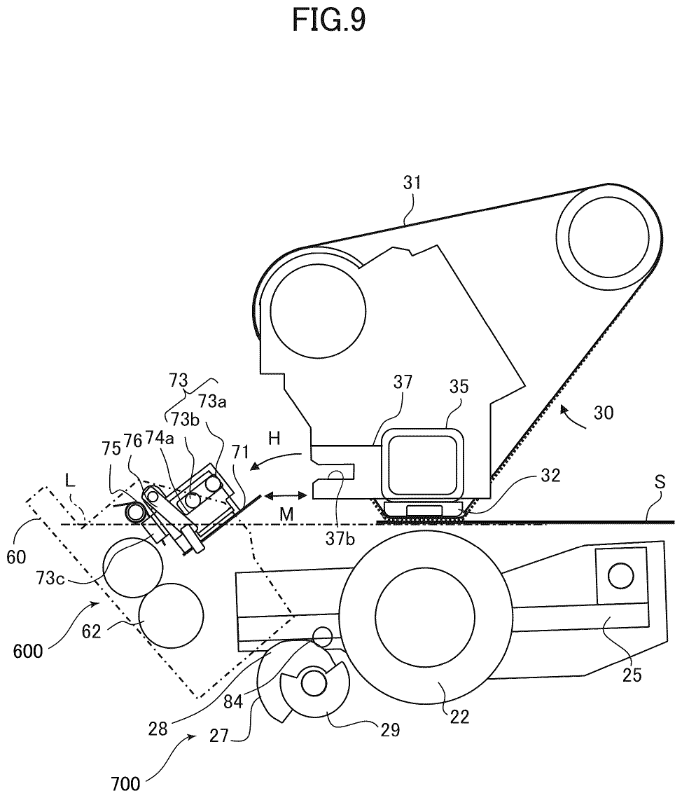

Next, an effect of expansion of the jam processing space by the separation plate 71 moving to the retraction position as described above will be described in detail with reference to FIGS. 9 and 10. FIG. 9 illustrates a state in which the discharge unit 60 is opened for the jam processing (a state in which the discharge unit has moved to the open position) in a comparative example. The comparative example illustrated in FIG. 9 has a configuration in which the separation plate 71 does not move to the retraction position. When the discharge unit 60 rotates in an H direction about the pivot shaft 84, a jam processing space M appears between the discharge unit 60 and the fixing belt 31. At this time, since the separation plate 71 is biased to the separation position by the torsion coil spring 75, the separation plate 71 remains protruding toward the fixing nip portion N. Therefore, there is a possibility that the space M for taking out the jammed sheet at the time of the jam processing cannot be fully secured, and a user touches the separation plate 71.

In particular, since the sheet is removed by putting a hand from above the space M at the time of performing the jam processing, it is difficult to perform an operation of removing the sheet when the separation plate 71 remains protruding as in the comparative example. That is, a virtual plane obtained by extending a nip surface (a surface formed between the pressure roller 22 and the fixing belt 31 in a state in which the pressure roller 22 is pressurized against the fixing belt 31) of the fixing nip portion N in a direction in which the sheet is discharged from the fixing nip portion N is defined as a virtual plane L. In this case, a position of the distal end of the separation plate 71 when the discharge unit 60 is positioned at the open position is vertically above the virtual plane L. Therefore, when the separation plate 71 remains protruding, the space M becomes small, and it is difficult to perform the operation of removing the sheet.

On the other hand, FIG. 10 illustrates a state in which the discharge unit 60 is opened for the jam processing in the configuration of the present embodiment. When the discharge unit 60 rotates in the H direction about the pivot shaft 84, the jam processing space M appears between the discharge unit 60 and the fixing belt 31. At this time, the separation plate 71 is biased by the retraction lever 78 and the torsion coil spring 79 with a stronger force than that of the torsion coil spring 75, thereby moving to the retraction position. Therefore, the separation plate 71 is positioned at a position about 20 mm away from the fixing nip portion, and the space M for taking out the jammed sheet at the time of the jam processing can be fully secured. In addition, by retracting the separation plate 71 into the frame of the discharge unit 60, a possibility that the user touches the separation plate 71 is reduced.

In the present embodiment, the position of the distal end of the separation plate 71 when the separation plate 71 is positioned at the retraction position and the discharge unit 60 is positioned at the open position is vertically above the virtual plane L. However, unlike the comparative example, the separation plate 71 is positioned at the retraction position, and thus, the space M can be sufficiently secured even if the distal end of the separation plate 71 is above the virtual plane L. Therefore, it is easy to perform the operation of removing the sheet by putting the hand from above the space M.

As described above, in the fixing device 20 of the present embodiment, the separation plate 71 is movable between the separation position and the retraction position, and the separation plate 71 is present at the retraction position when the discharge unit 60 can be opened and closed, so that the space for the jam processing can be secured. Therefore, even with a configuration including the separation plate 71, the jam processing is easily performed.

### Other Embodiments

In the above-described embodiment, the discharge unit 60 is moved to the open position at the time of the jam processing. However, the discharge unit 60 may be maintained at the closed position at the time of the jam processing, and the separation plate 71 may be moved to the retraction position in conjunction with an operation of separating the pressure roller from the fixing belt 31.

In the above-described embodiment, a configuration in which the halogen heater serving as a heating unit for heating the fixing belt is provided in the heating roller has been described. However, the heating unit may be provided not in the heating roller but in another tensioning member. Alternatively, the heating unit may be provided on the pad member. For example, a plate-shaped heat generation member such as a ceramic heater may be provided on a fixing belt side of the pad member. The fixing belt may be heated by electromagnetic induction (IH). In each embodiment described above, instead of the heating unit disposed inside the roller, an external heating system in which another heating member is brought into contact with the belt or the roller from the outside for heating may be adopted.

Furthermore, in the above-described embodiment, a configuration using the pressure roller as a drive rotary member has been described. However, the drive rotary member may be an endless belt stretched by a plurality of tensioning rollers and driven by any one of the tensioning roller. In each embodiment described above, the pressure roller serving as the drive rotary member is pressurized against the belt in order to form the nip portion. However, the belt may be pressurized against the drive rotary member. Furthermore, in each embodiment described above, a configuration using the fixing pad as the nip portion forming member has been described, but the nip portion forming member may be a roller.

In the above-described embodiment, the first movement mechanism is the separation plate movement mechanism 700 including the plurality of arms, levers, and the like. However, as long as the separation plate 71 is movable, the first movement mechanism may include other mechanisms such as a conventionally known link mechanism, a conventionally known cam mechanism, and a combination thereof. Further, the first movement mechanism is preferably configured to operate in conjunction with the second movement mechanism which is a mechanism for separating the second rotary member from the first rotary member, but the first movement mechanism does not have to operate in conjunction with the second movement mechanism. Further, the first movement mechanism may operate in conjunction with the third movement mechanism that moves the unit to a position where the jam processing is performed. In short, it is sufficient if the separation member is positioned at the second position (retraction position) in a state in which the unit is positioned at the fourth position (open position).

In the above-described embodiment, the first rotary member is the fixing belt, but the first rotary member may also be a roller. The second rotary member is the pressure roller, but the second rotary member may also be an endless belt. That is, the first rotary member and the second rotary member may be rollers or belts. In the above-described embodiment, the separation member is a metal plate. However, the separation member may be a resin plate member or a sheet-like member. Furthermore, in the above-described embodiment, the separation member is the separation plate that is a plate-like member, but the separation member may be, for example, a substantially rectangular parallelepiped member having a rectangular cross section, and the recording material may be separated by bringing a corner portion of the member close to the first rotary member.

According to the present disclosure, in a configuration including the separation member, the belt and the separation member can be prevented from coming into contact with each other even if the belt is separated.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-160020, filed Sep. 17, 2024, and Japanese Patent Application No. 2025-107223 filed Jun. 25, 2025 which are hereby incorporated by reference herein in their entirety.

What is claimed is:

1. A fixing device configured to heat a toner image borne on a recording material and fix the toner image to the recording material, the fixing device comprising:
a first rotary member;
a second rotary member configured to come into contact with the first rotary member and form a nip portion at which the recording material is nipped and conveyed between the second rotary member and the first rotary member;
a separation member disposed downstream of the nip portion in a conveyance direction of the recording material and configured to separate the recording material having passed through the nip portion from the first rotary member;
a separation member supporting portion configured to support the separation member so as to be movable between a first position and a second position;
a first movement mechanism configured to move the separation member between the first position and the second position; and
a second movement mechanism configured to move the second rotary member between a contact position where the second rotary member comes into contact with the first rotary member and a separated position where the second rotary member is separated from the first rotary member, wherein
the first position is a position where, in a case where the second rotary member is at the contact position, a distal end of the separation member faces the first rotary member via a predetermined gap, and the recording material having passed through the nip portion is separable from the first rotary member by the separation member,
the second position is a position where, in a case where the second rotary member is at the separated position, the distal end of the separation member is farther from the first rotary member than in the first position, and
the separation member is configured to move from the first position to the second position by the first movement mechanism in conjunction with an operation in which the second rotary member moves from the contact position to the separated position by the second movement mechanism.

2. The fixing device according to claim 1, further comprising a third movement mechanism configured to move a unit including the separation member and the separation member supporting portion between a third position where a downstream side of the nip portion is not opened and a fourth position where the downstream side of the nip portion is opened in the conveyance direction of the recording material,
wherein the separation member is positioned at the second position in a state in which the unit is positioned at the fourth position.

3. The fixing device according to claim 2, wherein the separation member is configured to move from the first position to the second position by the first movement mechanism in a state in which the unit is positioned at the third position.

4. The fixing device according to claim 2, wherein the unit includes a conveyance portion disposed downstream of the nip portion in the conveyance direction of the recording material and configured to convey the recording material having passed through the nip portion.

5. The fixing device according to claim 1, wherein the first movement mechanism includes a biasing portion configured to bias the separation member toward the first position, allows the separation member to be biased by the biasing portion and positioned at the first position in a state in which the second rotary member is positioned at the contact position, and positions the separation member at the second position against a biasing force of the biasing portion in a state in which the second rotary member is positioned at the separated position.

6. The fixing device according to claim 2, wherein
the first rotary member is an endless belt, and
the fixing device further comprises:
a nip portion forming member disposed on an inner side of the belt at a position facing the second rotary member via the belt and configured to form the nip portion between the belt and the second rotary member;
a supporting member disposed on the inner side of the belt and configured to support the nip portion forming member; and
a positioning member provided on the supporting member and configured to position the separation member at the first position.

7. The fixing device according to claim 6, wherein the positioning member includes a guide portion configured to guide the separation member to the first position and the second position in a state in which the unit is positioned at the third position.

8. The fixing device according to claim 7, wherein the unit includes a separation-member-side engagement portion configured to be engaged with the guide portion in the state in which the unit is positioned at the third position and be disengaged from the guide portion in a case where the unit moves from the third position to the fourth position.

9. The fixing device according to claim 8, wherein
the separation-member-side engagement portion is configured to move between the first position and the second position together with the separation member, and
the separation member supporting portion includes a supporting-portion-side guide portion configured to guide the separation-member-side engagement portion to the first position and the second position.

10. The fixing device according to claim 2, wherein
the third movement mechanism includes a pivot shaft pivotably supporting the unit and is configured to pivot the unit about the pivot shaft between the third position and the fourth position, and
a position of the distal end of the separation member in a case where the separation member is positioned at the second position and the unit is positioned at the fourth position is vertically above a virtual plane obtained by extending a nip surface of the nip portion in a direction in which the recording material is discharged from the nip portion.
